(19) United States
(12) Patent Application Publication
(10) Pub. No.: US 2007/0084996 A1
(43) Pub. Date: Apr. 19, 2007

(54) Method of preventing analyte alteration in diagnostic apparatuses involving contact of liquid and electrode

(75) Inventors: Jie Li, Ithaca, NY (US); Thomas N. Corso, Groton, NY (US)

Correspondence Address: NIXON PEABODY LLP - PATENT GROUP, CLINTON SQUARE, P.O. BOX 31051, ROCHESTER, NY, 14603-1051, US

(73) Assignee: Advion BioSciences, Inc., Ithaca, NY (US)

(21) Appl. No.: 11/580,785

(22) Filed: Oct. 13, 2006

Related U.S. Application Data
(60) Provisional application No. 60/727,159, filed on Oct. 14, 2005.

(51) Int. Cl. B01D 59/44

(52) U.S. Cl. 250/282

(57) ABSTRACT

A method of preventing analyte electrolysis in use with electrospray ionization, electrophoresis, electro osmosis, electrodialysis and any apparatuses involving contact of liquids and electrodes is disclosed. The method for preventing analyte alteration by electrolysis reactions at electrode surfaces of an electrochemical system and in an electrochemical process includes coating the electrode surface using electrically insulating material including but not limited to polymers, plastics, and organic compounds by coating methods including but not limited to liquid spraying, spinning, molding, Sol Gel, dipping, physical vapor deposition and chemical vapor deposition at various ambient and substrate temperatures.

This application claims the benefit of U.S. Provisional Patent Application Ser. No. 60/727,159, filed Oct. 14, 2005, which is hereby incorporated by reference in its entirety.

### FIELD OF THE INVENTION

The present invention relates to a method for preventing analyte alteration at the surface of an electrode in systems involving electrochemical reactions and processes, and associated structures and devices.

### BACKGROUND OF THE INVENTION

Electrospray ionization (“ESI”) in conjunction with mass spectrometry (“MS”) has become one of the core techniques in the field of biotechnology and the life sciences. The ESI/MS has become one of the most powerful analytical techniques for qualitative and quantitative measurements. The understanding of the ESI process is an ongoing effort. There are still challenges in the development and improvement of ESI applications, such as analyte oxidation, sensitivity and linearity of analyte ionization. Particularly troublesome are the problems relating to analyte oxidation.

ESI provides a process for transferring ions in solution to ions in the gas phase. This process can be achieved at atmospheric pressure or slight variations thereof. Traditionally, liquid is supplied through a small “needle-like” spray emitter that has a large electric potential difference with respect to surrounding objects and counter electrode. For ESI working in positive ion mode, the emitter needle is normally several thousand volts higher in potential than the counter electrode. Given that the solution contains free ions, this potential difference causes inductive charging by positive ions on the liquid surface at the tip of the emitter. The accumulation of positive ions at the liquid surface eventually provides enough electric force to overcome the liquid surface tension and results in pulling-out of the liquid in the form of a jet and/or droplets. Meanwhile, the electric field penetrates the liquid and pushes negative ions towards the emitter. With positive ions being ejected, there are excess negative ions at the vicinity of the spraying tip, causing decrement in positive potential. This potential decrement is equalized through the conductive liquid path all the way to the positive electrode where high voltage is applied. The depletion of positive ions at the emitter's tip is quickly reflected by build-up of a potential difference across the interface between the liquid solution and the positive electrode, resulting in oxidation of ions and neutral molecules including analytes in the solution. The oxidation process at the interface transfers electric charge from the power supply to the liquid solution and sustains steady electrospray. The interface potential difference determines what species in the solution can be oxidized. Species that have the lowest oxidation energies often get oxidized first. If this does not provide sufficient electric current to support the spray, the interface potential difference increases to oxidize species of higher oxidation energies. This oxidation process is influenced by spray voltage, liquid conductivity, area of liquid-electrode interface, exposure time to electrode, liquid flow rate and geometric configuration. For the inverse process when implementing ESI with negative potentials, reduction of chemical species results.

Therefore, oxidation and reduction is an inherent part of the electrochemical process of ESI as implemented today. Unfortunately, this electrochemistry causes alterations of analyte molecules, contents, and compositions of the sprayed liquid solution. Indirect alteration of sample species in solution may occur as a result of the electrochemical change of the solution which in turn causes secondary reactions with the sample contained in the solution. Multiple approaches have been reported to attack this problem. Metal materials that have low oxidation energies have been used as the positive electrode. These metals are so easily oxidized that the electrode sacrifices itself before any analytes are oxidized. This causes corrosion of the electrode and the presence of metal ions in the solution. Metal adducts are often seen in analyte mass spectra. High solution flow rate (short exposure times to the electrode) was proved to reduce analyte oxidation. This is why the conventional large column LC/ESI doesn't have a serious concern about analyte oxidation. However, nanoESI with micro-column LC, which provides much higher sensitivity and is widely used in today's proteomic research, cannot benefit from this finding because low flow rates result in long exposure times. Based on the assumption that an analyte molecule has to physically reach the surface of the electrode to be oxidized, researchers proposed to reduce the area of the interface between the electrode and solution. This was proved useful to reduce analyte oxidation. But it is not able to eliminate oxidation. Moreover, a smaller area electrode must provide higher current density to sustain the same electrospray. This will increase the interface potential difference and cause oxidation of analytes of higher oxidation energies. Low solution conductivity was reported to be better in dealing with this problem. The rationale is that less electrospray current with a low conductivity solution requires less oxidation at the positive electrode. This is obviously not the final solution to this problem, let alone it only impacts restricted kinds of samples and solvent systems. Of course, lower electrospray voltages help reduce analyte oxidation in the same way. But this may sacrifice ionization efficiency and is thus not a desirable or realistic solution to the problem.

A research group reported recently that they were able to control analyte electrochemical oxidation in ESI using another controlled-potential electrochemical cell. This cell was operated with an electrically floated voltage source so that the electric circuit loops of this cell and the ESI cell were independent of each other, although the two cells shared the same chemical solution. The electrode of this added cell was placed before the ESI emitter (the needle) but after the electrode of the ESI cell. When oxidized analyte molecules passed the electrode of the added cell, the operation voltage was adjusted to allow electrochemical reduction in the solution, in the hope that this would eliminate any oxidation effect on analytes in the ESI cell. This approach shows an understanding of electrospray electrochemistry. However, this proposed solution adds complication and cost to an ESI system. Further, this proposed solution may not be very practical and user-friendly because appropriate voltage is needed to counter-act against the analyte oxidation in an ESI cell for each and every sample and spray condition. This is especially hard to do in the case of LC/ESI. This type of approach also adds additional dead-volume and makes the approach less applicable to systems requiring separation quality.

Successful elimination of analyte oxidation was reported by using a membrane in the solution in front of an ESI electrode. The membrane was semi-permeable which allowed the ions of the solution to pass through and exchange charges at the electrode surface, but blocked large analyte molecules from reaching the electrode. Although this approach may not be practical because it is difficult to have the variety of membranes that are needed to fit for different kinds of sample solutions, nevertheless, the idea that this approach prevents physical access of analyte molecules to the ESI electrode remains significant. The art needs a new way to separate analytes from the ESI electrode while letting electric current flow through to sustain electrospray.

The typical electrospray ion source used in mass spectrometry is a two-electrode, controlled-current electrochemical flow cell. A metal capillary or other conductive contact placed at or near the point from which the charged electrospray droplet plume is generated is one of the two electrodes in the system. The analytically significant reactions in terms of ESI-MS occur at this electrode acting as the working electrode in the system. The counter electrode of the circuit is usually the atmospheric sampling aperture plate or inlet capillary and the various lens elements and detector of the mass spectrometer. To sustain the production of charge droplets from the ESI source, an electrochemical reaction must occur at the conductive contact with the solution at the spray end of the ESI device. Oxidation reactions in positive ion mode and reduction reactions in negative ion mode dominate at the emitter electrode, whereas reduction reactions in positive ion mode and oxidation reactions in negative ion mode dominate at the counter electrode.

In as much as the specific analyte ions and their respective abundances observed in an ES mass spectrum are related to the solution composition, the electrochemical reactions that take place at the ESI emitter electrode may influence the gas-phase ions formed and ultimately analyzed by the mass spectrometer. This is because the electrochemical reaction at the emitter electrode can change the composition of the solution that initially enters the ES ion source. Of particular interest are those electrochemical reactions and compositional changes that directly involve the analytes. These reactions include electrochemical ionization that can be exploited to ionize neutral electroactive analytes that would otherwise go undetected in ES-MS. Other reactions include those that modify the mass, structure, or charge of the analyte and those that can remove analytes from solution (Karancsi et al., Rapid Commun. Mass Spectrom. 11:81-84 (1997); Berkel et al., J. Mass Spectrom. 35:773-783 (2000)). Reactions of the later types might be troublesome for analyses involving unknown analytes or quantification. The ability to control the extent of any or all of these analyte electrochemical reactions would be an analytical advantage. The advantages include avoiding confusion in analysis of unknown—changes in mass or charge, preserving initial solution state of analyte and avoiding distribution of charge among different ionic species. Some common measures can be taken to reduce analyte electrolysis, including the use of a sacrificial electrode, addition of redox buffer in solution, use of high solution flow rate, reducing electrode area, lowering solution conductivity, and applying less electrospray voltage.

The interfacial potential at the working electrode, the magnitude of the ES current, the nature of the electrode surface, and the mass transport of the analyte to the electrode are all important parameters in determining which reactions can occur at the emitter electrode, their rates, and their extent. The interfacial potential of the ES emitter electrode, for a given applied voltage, is not fixed, but rather adjusts to a given level depending upon a number of interactive variables to provide the required current. These variables include the magnitude of the ES current, the redox character and concentrations of all species in the system, the solution flow rate, the electrode material, geometry, and area, and any other parameters that affect the flux of reactive species to the electrode surface.

### SUMMARY OF THE INVENTION

Although various research and apparatuses have attempted to reduce analyte alteration caused by electrochemical reactions at the solution/electrode interface, there is still no simple and universal way to eliminate analyte electrolysis. The present invention addresses this issue and provides a simple, convenient and universal method to prevent electrochemical-reaction-induced analyte alteration at the electrode in solution.

In accordance with one aspect of the present invention there is provided a method for preventing the alteration of an analyte induced by an electrochemical reaction at the surface of an electrode in a solution of an electrochemical system. The method includes providing an electrochemical system having an electrode, a counter electrode, and an analyte in a solution between the electrode and counter electrode. The electrode is coated with a dielectric material that is an electrically insulating material which prevents the coated electrode from coming into physical contact with the analyte in the solution. An electrical current is passed through the solution between the two electrodes to create an electrochemical reaction. The electrode coating is inert to the solution and the analyte is prevented from being altered by the electrochemical reaction.

This and other aspects of the present invention will become apparent upon a review of the following detailed description and the claims appended thereto.

### BRIEF DESCRIPTION OF THE DRAWINGS

FIG. 1 is a schematic demonstration of nanoelectrospray using Advion ESI chip technology, Advion BioSciences, Inc., Ithaca, N.Y.

FIG. 2 is the mass spectra resulting from the infusion of reserpine, without a fluoropolymer coating on the conductive pipette tip (electrode) FIG. 2(A) and with a fluoropolymer coating on the conductive pipette tip (electrode) FIG. 2(B).

FIG. 3 shows the extracted ion current traces of m/z=609 (reserpine) resulting from the infusion of a 500 femtomole solution of reserpine dissolved in 50/50 methanol and water with the addition of 0.1% acetic acid, using an uncoated pipette tip (electrode) FIG. 3(A) and using a coated pipette tip (electrode) FIG. 3(B).

### DETAILED DESCRIPTION OF THE INVENTION

The present invention relates to a method for preventing the alteration of an analyte induced by an electrochemical reaction at the surface of an electrode in a solution of an electrochemical system. The method includes providing an electrochemical system having an electrode, a counter electrode, and an analyte in a solution between the electrode and counter electrode. The electrode is coated with a dielectric material that is an electrically insulating material which prevents the coated electrode from coming into physical contact with the analyte in the solution. An electrical current is passed through the solution between the two electrodes to create an electrochemical reaction. The electrode coating is inert to the solution and the analyte is prevented from being altered by the electrochemical reaction.

The present invention provides a method to prevent analyte electrolysis in electrochemical systems including electrospray ionization, electrophoresis, electro osmosis, electrodialysis and any systems or apparatuses involving the contact of liquids and electrodes, such as those described in the background above.

In a further embodiment, the coating is optionally, conformal and uniform, and also can be non-conformal and non-uniform. The coating is single layered, or multiple layered. The thickness of the coating is preferably in the range of from 0.1 microns to 100 microns, more preferably about one micron. The thickness may be increased if necessary.

In one embodiment, the coating deposition includes liquid casting, Sol Gel technique, spraying, spinning of the electrode, and dipping of the electrode into a coating solution. The coating can also be deposited by gas phase deposition, which includes all types of physical vapor depositions and chemical vapor depositions. The coating can also be formed by polymer or other organic material growth in solution or in a gas phase environment.

According to another embodiment, the coating is deposited or grown on the surface of the electrode with or without a pre-treatment of the electrode surface.

The pre-treatment of the electrode includes priming the surface, roughing or smoothing the surface, high temperature or plasma treatment of the surface, and coating of conductive or semiconductive materials on the surface.

According to a further embodiment, the coating can be deposited or grown, or be subject to after-coating treatment processes. The after-coating treatment processes include chemical treatment in a gas phase or in solution, physical treatment of elevated temperature in air or certain gases, of plasma treatment and of bombardment or sputtering treatment by energetic molecules or ions.

The coating hardness properties may be designed for the coating material to be used as a gasket material. For example, the material may be used for sealing of the electrode to another substrate or in combination with a system containing the liquid. For instance, the coupling of a pipette tip to an electrospray chip is envisioned. A hard version of the material may be desired if needed to perform a mechanical or other like feature of a system.

The coating is preferably inert as to limit interactions or incompatibility with the sample or solution. Various types of flouropolymer formulations may be implemented as the coating material.

This method provides a coating on the surface of the electrodes to avoid direct physical contact of the analytes with the electrodes which prevents analyte electrolysis and/or alteration at the electrode. The coating material useful for the coating on the electrode surface is an electrically insulating material and a dielectric. In this manner, the coated electrode still functions as an electrically conductive electrode.

Materials that can be used for this coating include, but are not limited to, all fluorinated polymers, Teflon, polypropylenes, polymethyl methacrylate, polyethylenes, polyamides, all types of waxes, mixtures of different polymers, PVC, PVDP, viton, norprene, hypalon, polyurethane, silicone, vinyl, PTFE, neoprene, kapton, and the like. Suitable coating material further includes any form of polymers, plastics, organic compounds, elastomers, monomers, inorganic-organic compounds. and mixtures thereof. Materials also include, but are not limited to, mixtures of polymers and inorganic compounds, mixtures of polymers and particles of inorganic materials, mixtures of particles of polymers, and polymers containing inorganic elements. For example, a polypropylene can contain carbon particles, glass particles, silicon particles, or ceramic particles. The coating materials further include polymers of uncross-linked or cross-linked, monomers, polymers, plastics, organic materials, elastomers, waxes, and the like.

The electrode material includes, but is not limited to, the following: gold, platinum, silver, copper, iron, tungsten, palladium, aluminum, all types of stainless steel, all metal elements and their alloys or mixtures, all electrically conductive materials, silicon, germanium, silicon carbide, GaAs, GaN, AlN, all semiconducting elements or compounds, conductive polymers, conductive organic compounds, graphite, carbon, carbon doped polymers, and mixture of polymer and conductive particles.

When the electrodes or substrate of the electrochemical system are coated the coating is inert with respect to the analyte solution. The coating is not oxidized or dissolved by the analyte solution. Moreover, neither the analytes nor other components within the analyte solution are absorbed or adsorbed on the surface of the coating. The coating on the surface of electrodes prevents analyte alterations in the electrospray ionization system. The coating on the surface of the electrodes prevents analyte from being chemically oxidized, reduced, broken, segmented or from forming adducts in the electrospray ionization system.

The coating is in physical contact with the solid surface of the electrode, therefore there is no solution between the coating and the electrode. This provides a coating on the surface of the electrode in the electrospray ionization system which is an electrically insulating material and dielectric in nature. Thus, the coated electrode of the present invention differs form a system wherein a membrane is provided to protect the analyte in solution wherein sample fluid is on both sides of the membrane, including wherein sample fluid is between the membrane and the electrode. The coating on the surface of electrode physically separates the coated surface of the electrode from the sample fluid being sprayed.

The electrode to be coated can be of any shape. The electrode surface can be smooth or rough. The coated electrode surface can be located anywhere in an electrochemical system that is in contact with the analyte-containing solution.

Generally, a method performed according to the principle of this present invention can include a combination of some or all of the following steps: (1) forming a coating solution by dissolving coating material or materials into solvent or mixture of solvents; (2) forming a coating solution by mixing two or more solutions or solvents and letting them mix physically and/or react chemically; (3) forming a coating solution or suspension containing the coating material; (4) preparing a sputter system and target material for physical sputter deposition; (5) preparing a sputter system, target material and sputter gases for physical chemical reactive sputter deposition; (6) preparing a thermal evaporation system and materials to be evaporated for physical vapor deposition; (7) preparing a thermal evaporation and chemical reaction system and materials to be evaporated for physical chemical deposition; (8) preparing a chemical vapor deposition system and gases that participate in the chemical reaction for chemical vapor deposition; (9) preparing a vacuum system for ion deposition; (10) preparing a substrate, e.g., the electrode to be used in an electrochemical system, for receiving deposition of a coating by heating the substrate, plasma treating the substrate, polishing or roughing the substrate, priming the substrate, and the coating thereon of thin conductive and/or nonconductive layers; (11) spraying the formed coating solution onto the surface of the electrode to form a layer covering the surface; (12) dipping the electrode into the formed coating solution, or applying the formed coating solution onto the surface of the electrode to let form a layer of the formed solution on the electrode surface; (13) blowing the surface of the electrode with air or nitrogen to let form a layer of the formed solution on the electrode surface; (14) forming a layer of coating on the electrode using a Sol Gel technique; (15) heating the coated electrode at elevated temperatures for a period of time to drive out the solvents from the coating; (16) placing an electrode into the prepared sputter system and performing sputtering to deposit a layer of coating on the surface of the electrode; (17) placing an electrode into the prepared thermal evaporation system and depositing a layer of coating on the surface of the electrode; (18) placing an electrode into the prepared chemical vapor deposition system to deposit a layer of coating on the surface of the electrode; and (19) performing an after-deposition treatment of the coating using elevated temperature anneal, plasma treatment, ion bombardment, or treatment of chemical reaction.

In one embodiment, the coating material is dissolved in solvent to form a coating solution. The solvent can be organic or inorganic or one of, or mixture of any of the following: water, methanol, ethanol, butanol, acetone, acetonitrile, acetonchloride, isopropanol, methanol chloride, or fluorinated based. Preferably, the material is dissolved in the solvent at room temperature or at elevated temperature with or without stirring. Preferably, the coating material concentration in the coating solution is in the range of from 0.01 grams per liter to 5000 grams per litter.

The coating solution can be made by mixing two or more solutions and/or solvents and letting them mix physically and/or react chemically. The physical mixing can be by diffusion, stirring or ultrasound at room temperature or at elevated temperature. Preferably, the composition of the formed solution is in the range of from 0.01 grams per liter to 5000 grams per litter.

The coating liquid can be a suspension of the coating material in solvent or solution. The suspension can be formed by chemical reaction or by energetic physical mixing. Preferably, the concentration of the suspension is in the range of from 0.01 grams per liter to 5000 grams per liter.

In one embodiment, the coating solution or suspension is sprayed on the electrode surface to form a coating. The coating solution or suspension can be applied on the electrode surface and distributed more evenly on the surface by spinning the electrode. In another embodiment, the electrode is dipped into the coating solution or suspension to form a coating layer on the surface. In case there is a need to remove excess solution or suspension, or distribute the solution or suspension more evenly on the surface, nitrogen or air may be used to blow the coated surface of the electrode.

Preferably, this coating is followed by thermal, plasma, energetic particles, or chemical treatment of the electrode. The thermal treatment includes annealing at elevated temperature in an inert gas or air environment. The annealing temperature is in the range of from 20° C. to 800° C. This coating process can be repeated multiple times to increase the coated layer thickness.

The coating material can also be heated to be thermally evaporated in a vacuum or in a certain gas environment and be deposited on the electrode. The electrode can be at an elevated temperature ranging of from 20° C. to 500° C., and the environment pressure can be in the range of from 0.001 Torr to 760 Torr.

In another embodiment of this invention, the coating material acts as a gasket to seal the electrode in solution in an electrochemical system where the liquid solution is required to be under pressure.

In still another embodiment of this invention, the coating on the electrode has the effect of reducing or eliminating any adsorption or absorption of analyte molecules on the electrode surface. An additional benefit of this coating is that it can be formulated to limit adsorption or absorption at the surface of other parts of the system to which it is coated independent of the electrochemical reaction. The analyte molecules, which can be adsorpted or absorpted on an uncoated electrode surface, include but are not limited to DNAs, proteins, peptides, small molecules and any polymer or organic molecules.

The invention will be further illustrated with reference to the following specific example. It is understood that this example is given by way of illustration and is not meant to limit the disclosure or the claims to follow.

### EXAMPLE

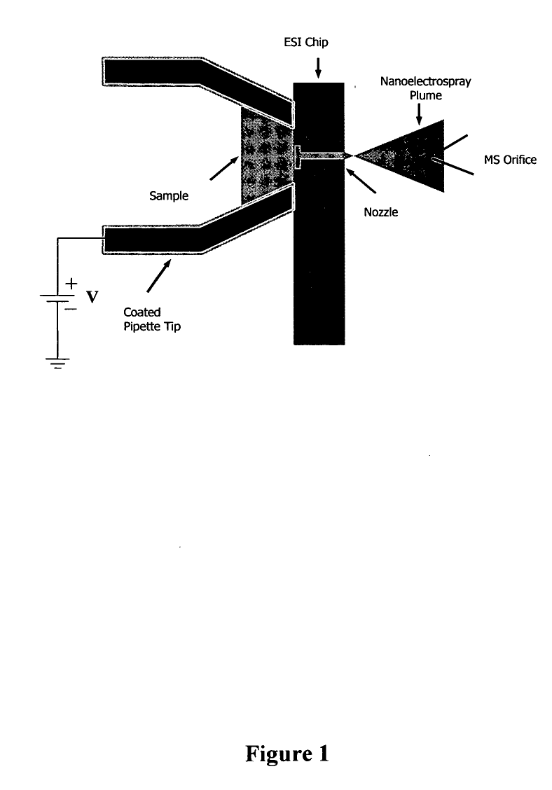

A conductive polymer or plastic pipette tip is used in the ESI chip technology of Advion Biosystem, Inc. to pick and deliver liquid sample to the ESI chip. High ESI voltage is applied to this tip during spraying. This tip is in contact with sample solution being sprayed and acts as the working electrode in the ESI circuit, as seen in FIG. 1. FIG. 1 is a schematic demonstration of nanoelectrospray using Advion ESI chip technology, Advion BioSciences, Inc., Ithaca, N.Y. The uncoated polypropylene pipette tip is doped with graphite and is electrically conductive. The pipette tip is coated with a fluorinated elastomer polymer. Due to the long dwelling time of sample solution in the pipette tip, analytes in the solution have a much higher chance to be electrolyzed (mainly oxidized or reduced). This invention is directed to solving the above-noted problem of electrolyzing the analytes by providing a coated electrode (pipette tip).

A coating solution is prepared by dissolving a commercially available fluorinated polymer elastomer in a flourinated solvent. The pipette tip is dipped into the coating solution and blown dry in air with nitrogen gas. A thin layer of the solution remains on the surface of the tip. The tip is baked at 60° C. in nitrogen for four hours to drive out the solvents. A thin layer of the fluorinated polymer is left coated on the surface of the pipette tip.

This polymer-coated pipette tip is used in the ESI chip technology of Advion to prevent any analyte electrolysis from taking place at the electrode/solution interface. The coating also acts as a gasket to help seal the liquid solution at the contact of the pipette tip and the ESI chip.

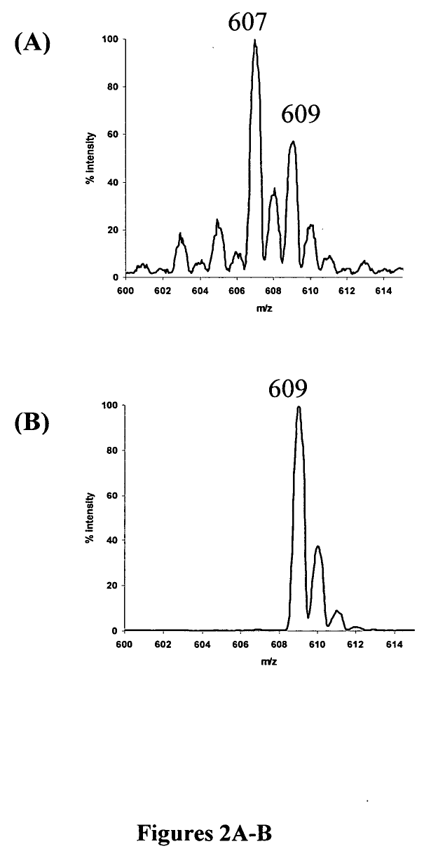

FIG. 2 is the resulting mass spectra from the infusion of reserpine, FIG. 2(A), without the fluoropolymer coating on the conductive pipette tip (electrode) and FIG. 2(B), with the fluoropolymer coating on the conductive pipette tip (electrode). For the non coated electrode, FIG. 2(A), the reserpine molecule undergoes a chemical change from m/z=609 to m/z=607 Daltons. FIG. 2(A) was obtained using an uncoated carbon pipette tip showing a strong peak at m/z=607 Daltons. The m/z=607 peak is the oxidation product of the reserpine molecule which appears at m/z=609 Daltons. For the spectrum shown in FIG. 2(B) which was obtained using the coated pipette tip, there is no alteration of the reserpine molecule and only the base peak of reserpine at m/z=609 Dalton results. Thus, the strong reserpine peak seen at m/z=609 Daltons appears without an oxidation product. The data for this example was generated by infusion of a 500 femtomole solution of reserpine dissolved in a 50/50 methanol and water mixture with the addition of 0.1% acetic acid. Nanoelectrospray of the solution was conducted at 1,300 volts and 0.3 psi pressure using Advion ESI-chip technology.

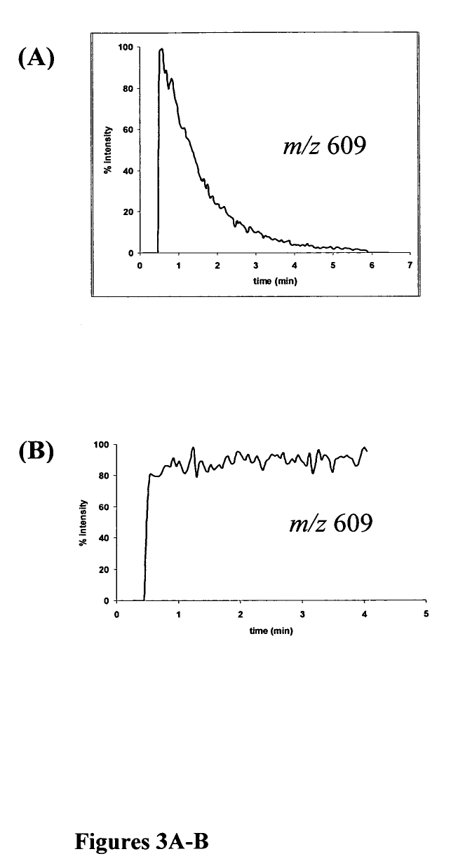

FIG. 3 shows the extracted ion current traces of m/z=609 (reserpine) resulting from the infusion of a 500 femtomole solution of reserpine dissolved in a 50/50 methanol and water mixture with the addition of 0.1% acetic acid from the above mass spectra. Nanoelectrospray of the solution was conducted at 1,300 volts and 0.3 psi pressure using Advion ESI-chip technology. The extracted FIG. 3(A) shows declining reserpine intensity with time when using an uncoated pipette tip. This indicates concentration reduction of the reserpine with time because of the electrolysis of reserpine molecules at the electrode (pipette tip). On the other hand, FIG. 3(B) shows constant signal intensity for the extracted ion m/z=609 (reserpine) when using a coated pipette tip (electrode). This indicates that the electrolysis induced alteration of reserpine molecules has been avoided.

While the invention has been described with preferred embodiments, it is to be understood that variations and modifications are to be considered within the purview and the scope of the claims appended hereto.

What is claimed is:

1. A method for preventing electrochemical-reaction-induced analyte alteration at the surface of an electrode in a solution of an electrochemical system, comprising:
providing an electrochemical system having an electrode, a counter electrode, and an analyte in a solution between the electrode and counter electrode;
coating the electrode with a dielectric material that is an electrically insulating material and which prevents the coated electrode from coming into physical contact with the analyte in the solution;
passing an electrical current through the solution between the two electrodes to create an electrochemical reaction, wherein the electrode coating is inert to the solution and the analyte is prevented from being altered by the electrochemical reaction.

2. The method according to claim 1, wherein the electrochemical system comprises electrospray ionization, electrophoresis, electro osmosis, electrodialysis or other electrochemical system involving the contact of liquids and electrodes.

3. The method according to claim 1, wherein the coating material comprises a fluorinated polymer, Teflon, polypropylene, polymethyl methacrylate, polyethylene, polyamide, imide, wax, mixtures of different polymers, PVC, PVDP, viton, norprene, hypalon, polyurethane, silicone, vinyl, PTFE, neoprene, kapton, mixtures of a polymers and an inorganic compound, mixture of a polymer and particle of inorganic material, or mixture of a particle of a polymer and a polymer containing an inorganic element.

4. The method according to claim 3, wherein the polymer containing an inorganic element comprises a polypropylene containing a carbon particle, glass particle, silicon particle, or ceramic particle.

5. The method according to claim 1, wherein the electrode, on which the coating is formed, comprises gold, platinum, silver, copper, iron, tungsten, palladium, aluminum, stainless steel, metal, metal alloys or mixtures, electrically conductive materials, silicon, germanium, silicon carbide, GaAs, GaN, AlN, semiconducting element or compound, conductive polymer, conductive organic compound, graphite, carbon doped polymer, or mixture of a polymer and conductive particle.

6. The method according to claim 1, wherein the electrode coating has a thickness in the range of from 0.1 microns to 100 microns.

7. The method according to claim 1, wherein the electrode is coated by a method comprising: (1) forming a coating solution by dissolving a coating material or materials into a solvent or mixture of solvents; (2) forming a coating solution by mixing two or more solutions or solvents and letting them mix physically and/or react chemically; (3) forming a coating solution or suspension containing the coating material; (4) preparing a sputter system and target material for physical sputter deposition; (5) preparing a sputter system, target material and sputter gases for physical chemical reactive sputter deposition; (6) preparing a thermal evaporation system and materials to be evaporated for physical vapor deposition; (7) preparing a thermal evaporation and chemical reaction system and materials to be evaporated for physical chemical deposition; (8) preparing a chemical vapor deposition system and gases that participate in the chemical reaction for chemical vapor deposition; (9) preparing a vacuum system for ion deposition; (10) preparing the electrode to be used in an electrochemical system, for receiving deposition of a coating by heating the electrode, plasma treating the electrode, polishing or roughing the electrode, priming the electrode, and coating thin conductive and/or nonconductive layers thereon; (11) spraying a formed coating solution onto the surface of the electrode to form a layer covering the surface; (12) dipping the electrode into a formed coating solution, or applying the formed coating solution onto the surface of the electrode to let form a layer of the formed solution on the electrode surface; (13) blowing the surface of the electrode with air or nitrogen to let form a layer of the formed solution on the electrode surface; (14) forming a layer of coating on the electrode using a Sol Gel technique; (15) heating the coated electrode at elevated temperatures for a period of time to drive out the solvents from the coating; (16) placing an electrode into the prepared sputter system and performing sputtering to deposit a layer of coating on the surface of the electrode; (17) placing an electrode into a prepared thermal evaporation system and depositing a layer of coating on the surface of the electrode; (18) placing an electrode into a prepared chemical vapor deposition system to deposit a layer of coating on the surface of the electrode; or (19) performing after-deposition treatment of the coating using elevated temperature anneal, plasma treatment, ion bombardment, or treatment of a chemical reaction.

8. The method according to claim 1, further comprising coating a non-electrode substrate of the electrochemical system with a material that prevents the substrate from coming into physical contact with the analyte present in the solution in contact with the coated substrate.

9. The method according to claim 8, wherein the coating material comprises a polymer, plastic, organic compound, elastomer, wax, inorganic-organic compound, and mixtures thereof.

10. The method according to claim 1, wherein the electrochemical-reaction-induced analyte alteration which is prevented comprises electrolysis, chemical oxidation, chemical reduction, physical breaking or segmenting, or forming adducts of the analyte.
